(19) United States
(12) Patent Application Publication
(10) Pub. No.: US 2024/0140503 A1
(43) Pub. Date: May 2, 2024

(54) FULL REDUNDANCY SPEED MEASUREMENT METHOD AND SYSTEM FOR RAIL

(71) Applicant: BYD COMPANY LIMITED, Shenzhen (CN)

(72) Inventors: Xingxing LIANG, Shenzhen (CN); Yejun QIN, Shenzhen (CN)

(73) Assignee: BYD COMPANY LIMITED, Shenzhen (CN)

(21) Appl. No.: 18/400,795

(22) Filed: Dec. 29, 2023

Related U.S. Application Data
(63) Continuation of application No. PCT/CN2022/106807, filed on Jul. 20, 2022.

(30) Foreign Application Priority Data
Jul. 30, 2021 (CN) 202110884557.6

(51) Int. Cl. B61L 25/02

(52) U.S. Cl. CPC B61L 25/021

(57) ABSTRACT

A full redundancy speed measurement method for a rail train includes: inputting a pulse signal and a phase difference of a multi-channel speed sensor into an active speed measurement system and a standby speed measurement system; performing switching between different multi-channel speed sensors and between different channel groups depending on whether the inputted signal is normal; determining a train running direction based on the phase difference, and calculating an speed value and an acceleration value through the pulse signal; processing the pulse signal of the multi-channel speed sensor, and determining whether the speed value of each channel is in a reasonable interval based on the speed value and the acceleration value of each channel, and determining whether the speed value of each channel in the reasonable interval conforms to the control logic; and performing a consistency voting on a speed value outputted, and outputting the train advancement direction and the speed value to a train control system if the consistency voting is approved.

### CROSS-REFERENCE TO RELATED APPLICATIONS

The present disclosure is a bypass continuation application of PCT International Application No. PCT/CN2022/106807, filed on Jul. 20, 2022, which claims priority to Chinese Patent Application No. 202110884557.6 on Jul. 30, 2021, and entitled “FULL REDUNDANCY SPEED MEASUREMENT METHOD AND SYSTEM FOR RAIL TRAIN”. The entire contents of the above-referenced applications are incorporated herein by reference.

### FIELD

The present disclosure relates to the technical field of train operation control, and more specifically, to a full redundancy speed measurement method and system for a rail train.

### BACKGROUND

In the related art, an independent speed measurement system is provided at front and rear ends of a train. This redundant speed measurement system at both ends cannot eliminate the fault during operation of the single-end speed measurement system. No logical determination for the speed output values from both ends affects the stability, safety, and practicality of a train control system to some extent.

### SUMMARY

Implementations of the present disclosure are intended to provide a full redundancy speed measurement method and system for a rail train, which can realize full redundancy speed measurement of the rail train, so as to improve stability, safety, and practicability of a train speed measurement system and a train control system.

In order to solve the above technical problems, an implementation of the present disclosure provides a full redundancy speed measurement method for a rail train, applicable to a full redundancy speed measurement system for a rail train. The full redundancy speed measurement system for a rail train includes a multi-channel speed sensor, an active speed measurement system, a standby speed measurement system, and an active/standby switching device, the multi-channel speed sensor has a plurality of dual-channel groups and the active speed measurement system and the standby speed measurement system both include a speed sensor detection and switching device, a logic processing device, an accelerometer device, and a speed measurement processing device. The method includes the following steps.
The active speed measurement system and the standby speed measurement system are operated.
The active/standby switching device is configured to perform switching between the active speed measurement system and the standby speed measurement system.
The multi-channel speed sensor has multiple dual-channel groups, and is configured to input a pulse signal and a phase difference to the active speed measurement system and the standby speed measurement system, where a phase difference exists between channels in the dual-channel groups.
The speed sensor detection and switching device receives the pulse signal inputted by the multi-channel speed sensor. The speed sensor detection and switching device detects whether power supply of the multi-channel speed sensor and the pulse signal are normal, and outputs the detected normal pulse signal to the accelerometer device and the speed measurement processing device, and performs switching between different multi-channel speed sensors and between different channel groups.
The accelerometer device receives the detected normal pulse signal and the phase difference, calculates a speed value and an acceleration value of each channel of each speed sensor based on the detected normal pulse signal and outputs the speed value and the acceleration value of each channel to the speed measurement processing device, and determines a train running direction based on phase difference.
The speed measurement processing device receives and processes the detected normal pulse signal, and determines whether the speed value of each channel is in a reasonable interval based on the speed value and the acceleration value of each channel and determines whether the speed value of each channel in the reasonable interval conforms to the control logic and outputs the speed value of each channel to the logic processing device.
The logic processing device receives the speed value of each channel outputted by the speed measurement processing device, and performs a consistency voting on the outputted speed value of each channel by the logic processing device.
A train running direction and the speed value are outputted to a train control system after the consistency voting is approved.

Further, when the active speed measurement system and the standby speed measurement system are operated, switching to the standby speed measurement system when the active speed measurement system shuts down due to a fault, where when the active speed measurement system resumes normality, switching of the speed measurement system is discontinued.

Further, the method further includes the following steps.
Power supply diagnosis and reporting to the control system are performed for fault repair if the speed sensor detection and switching device detects that a power supply state is abnormal.
A detection as to whether the multi-channel speed sensor and a channel pulse are normal is performed if the speed sensor detection and switching device detects that the power supply state is normal.

Further, the method further includes the following steps.
The pulse signal of the multi-channel speed sensor is normally outputted if the speed sensor detection and switching device detects that the multi-channel speed sensor and a channel pulse state are normal.
Switching is performed on the multi-channel speed sensor and the channel groups if the speed sensor detection and switching device detects that the multi-channel speed sensor and the channel pulse state are abnormal.

Further, the method further includes the following steps.
The multi-channel speed sensor and the channel pulse are detected again if switching of the multi-channel speed sensor and the different channel groups succeeds.
Guidance is provided to a safety side and reporting to the control system is performed for fault repair if the switching of the multi-channel speed sensor and the different channel groups fails.

Further, the method further includes the following step. A first accelerometer and a second accelerometer in the accelerometer device calculate speed values, acceleration values, and phase differences.

Further, the method further includes the following steps.
A first speed measurement processor and a second speed measurement processor of the speed measurement processing device process the pulse signal of the multi-channel speed sensor, and determine whether the speed value of each channel is in a reasonable interval based on the speed value and the acceleration value of each channel.
Control logic determination is performed on the speed values of channels of the multi-channel speed sensor if an speed value of each channel of the multi-channel speed sensor is in the reasonable interval.
It is determined whether a wheel slips if the speed value of each channel of the multi-channel speed sensor is not in the reasonable interval.

Further, the method further includes the following steps.
The accelerometer device compensates the speed value for the slipping if the wheel slips.
Detection and switching are performed on the multi-channel speed sensor and the channel groups if the wheel does not slip.

Further, the method further includes the following steps.
A first logic processor and a second logic processor of the logic processing device perform logic processing on the data outputted by the speed measurement processing device.
The speed values are outputted if the initial speed values of the channels of the multi-channel speed sensor conform to control logic.
The system provides guidance to the safety side and reports to the train control system for fault repair if the speed values of the channels of the multi-channel speed sensor do not conform to the control logic.

Further, the logic determination includes:
2-out-of-2 control logic and 3-out-of-4 control logic.

The 2-out-of-2 control logic requires that two groups of inputted speed values satisfy corresponding threshold conditions, and the threshold conditions depend on requirements for limiting values of operation processes of the multi-channel speed sensor and a related wheel.

The 3-out-of-4 control logic requires that four groups of inputted speed values satisfy corresponding threshold conditions, and the threshold conditions depend on requirements for limiting values of operation processes of the multi-channel speed sensor and a related wheel.

Further, a consistency vote is performed on a speed value of each channel outputted by the speed measurement processing device, it is determined that the vote is unanimous if a calculated result is within a set allowable error range, and a final speed value is outputted to the train control system.

Further, the logic processing device includes a first logic processor and a second logic processor;
the speed measurement processing device includes a first speed measurement processor and a second speed measurement processor; and
the accelerometer device includes a first accelerometer and a second accelerometer.

Further, the multi-channel speed sensor is composed of n dual-channel speed sensors, or composed of n/2 four-channel speed sensors, or composed of n/3 six-channel speed sensors.

### BRIEF DESCRIPTION OF THE DRAWINGS

One or more embodiments are exemplarily described with reference to the corresponding figures in the accompanying drawings, and these exemplary descriptions are not to be construed as a limitation on the embodiments. Elements in the accompanying drawings that have same reference numerals are represented as similar elements, and unless otherwise particularly stated, the figures in the accompanying drawings are not drawn to scale.

FIG. 1 is a flowchart of a full redundancy speed measurement method for a rail train according to an embodiment of the present disclosure;

FIG. 2 is a flowchart of detection and switching of a multi-channel speed sensor and a channel group according to an embodiment of the present disclosure;

FIG. 3 is a flowchart of calculating an speed value and an acceleration value of a train by an accelerometer device according to an embodiment of the present disclosure;

FIG. 4 is a flowchart of determining properness and control logic of the speed signal by a speed measurement processing device according to an embodiment of the present disclosure;

FIG. 5 is a flowchart of 2-out-of-2 control logic for a speed signal according to an embodiment of the present disclosure;

FIG. 6 is a flowchart of 3-out-of-4 control logic for a speed signal according to an embodiment of the present disclosure; and

FIG. 7 is a schematic diagram of a full redundancy speed measurement system for a rail train according to an embodiment of the present disclosure.

### DETAILED DESCRIPTION

To make the objectives, technical solutions, and advantages of embodiments of the present disclosure clearer, implementations of the present disclosure are described in detail below with reference to the accompanying drawings. However, a person of ordinary skill in the art may understand that in the implementations of the present disclosure, many technical details are provided for readers to better understand the present disclosure. However, even without these technical details and various changes and modifications based on the following implementations, the technical solution claimed in the present disclosure may also be implemented. The following examples are divided for the convenience of description, and should not constitute any limitation on the specific implementation of the present disclosure, and various embodiments may be combined with each other and cited without contradiction.

A first implementation of the present disclosure relates to a full redundancy speed measurement method for a rail train. The active speed measurement system and the standby speed measurement system simultaneously measure a speed of a train, and more than two multi-channel speed sensors are provided to input pulse signals and phase differences to the active speed measurement system and the standby speed measurement system. When the active speed measurement system shuts down due to a fault, the active/standby switching device performs switching. In this case, the standby speed measurement system is to complete the speed measurement of the train and output a speed value. During switching to the standby speed measurement system as the speed measurement system for controlling the train, performing switching between the active speed measurement system and the standby speed measurement system may cause speed measurement results to jump, and the speed measurement system should be set to allow short-time data jump during the switching. In this embodiment, the speed and distance jump caused by switching is not regarded as a fault of the speed measurement system. After switching to the standby speed measurement system to control the train, the operating status of the standby speed measurement system is subsequently monitored in real time, and it is not necessary to continue to check the status of the active speed measurement system. Even if the active speed measurement system recovers the speed measurement function and the train control function, switching of the speed measurement system is not performed, which can reduce the system switching burden and reduce the jump of the speed measurement result caused by the train control switching.

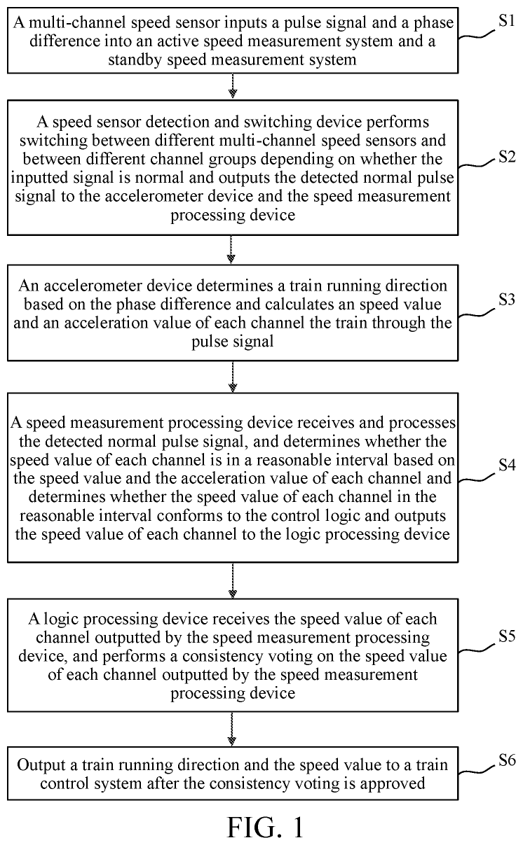

A process of a full redundancy speed measurement method for a rail train is shown in FIG. 1, including the following steps.

Step S1: A multi-channel speed sensor inputs a pulse signal and a phase difference into an active speed measurement system and a standby speed measurement system.

In this implementation, multiple dual-channel groups are provided for input of a pulse signal. A phase difference exists between two channel groups of the dual-channel groups, the pulse signal is used for calculating an speed value and an acceleration of train operation, and the phase difference is used for determining a train running direction.

Step S2: A speed sensor detection and switching device performs switching between different multi-channel speed sensors and between different channel groups depending on whether the inputted signal is normal and outputs the detected normal pulse signal to the accelerometer device and the speed measurement processing device.

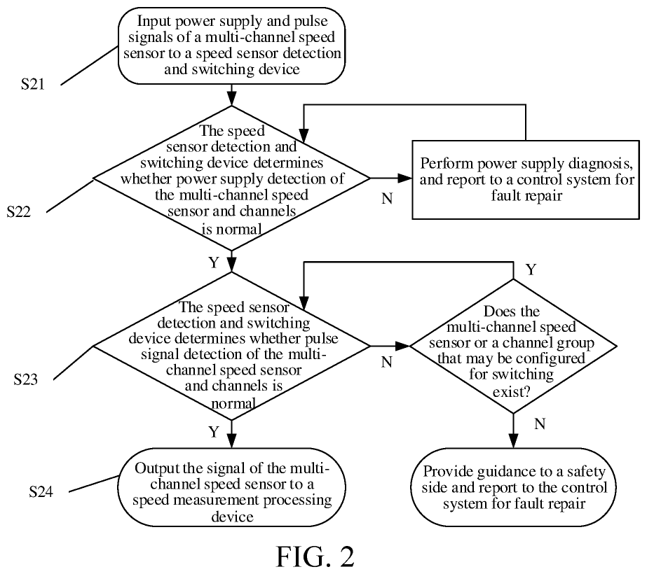

The process of performing detection and switching on the multi-channel speed sensor and the channel groups in this implementation is described in FIG. 2, including the following sub-steps:

Sub-step S21: Power supply and pulse signals of the multi-channel speed sensor are inputted to the speed sensor detection and switching device.

Sub-step S22: The speed sensor detection and switching device determines whether power supply detection of the multi-channel speed sensor and channels is normal, sub-step S23 is performed if the power supply detection is normal; power supply diagnosis is performed and reporting to the control system is performed for fault repair if the power supply detection is abnormal, and then step S22 is performed again.

Sub-step S23: The speed sensor detection and switching device determines whether pulse signal detection of the multi-channel speed sensor and channels is normal, when the pulse signal detection is normal, the detected normal pulse signal is outputted to an accelerometer device; and when the pulse signal detection is abnormal, if the multi-channel speed sensor or the channel groups that may be configured for switching exist, the system performs switching on the multi-channel speed sensor or the channel groups, and if no multi-channel speed sensor or channel groups that may be configured for switching exist, the system provides guidance to the safety side and reports to the control system for fault repair.

Sub-step S24: When power supply and pulse detection of the multi-channel speed sensor and channels is normal, the pulse signal of the multi-channel speed sensor is outputted to a speed measurement processing device.

In this implementation, the detection of the pulse signal may be detection of the pulse width of the pulse signal. A pulse signal width consistent with an interval value is preset, so that it may be determined whether the pulse signal is normal by detecting whether the pulse signal width value is within the interval value, or the pulse signal may be detected in another manner such as an oscilloscope. In addition, the detection of power supply may be detection of the voltage of the multi-channel speed sensor and channel, and it is determined whether the power supply detection is normal by detecting whether the voltage value is within the normal operating voltage range of the multi-channel speed sensor and channel. The speed sensor detection and switching device can effectively avoid inaccurate data measurement caused by the failure of a multi-channel speed sensor and channel.

Step S3: An accelerometer device determines a train running direction based on the phase difference and calculates an speed value and an acceleration value of each channel the train through the pulse signal.

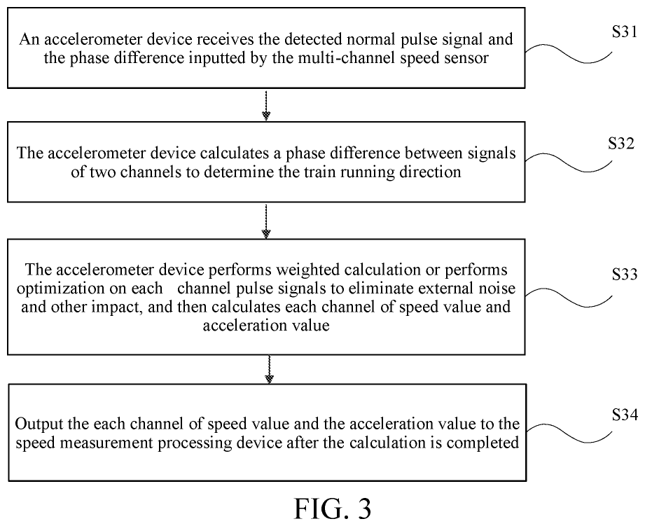

The process of calculating the speed value and the acceleration value of the train by the accelerometer device in this implementation is shown in FIG. 3, including the following steps:

Sub-step S31: The accelerometer device receives the detected normal pulse signal and the phase difference inputted by the multi-channel speed sensor.

In this implementation, the detected normal pulse signal is inputted by the multi-channel speed sensor which after the speed sensor detection and switching device has detected normal.

Sub-step S32: The accelerometer device calculates a phase difference between signals of two channels to determine the train running direction.

In this implementation, the received phase differences between signals of two channels are used for comparison, and a phase of the initial state of the train is recorded. Through comparison of the phase differences between signals of two channels, a dual-channel speed sensor includes channel 1 and channel 2. The phase difference of the dual-channel speed sensor used in this embodiment is 90°±30°, and the principle of determining the train advancement direction is as follows: if the phase difference of the channel 1 signal ahead of the channel 2 signal is within the phase difference range, it is determined that the train is traveling in a positive direction at this time; and if the phase difference of the channel 2 signal ahead of the channel 1 signal is within the phase difference range, it is determined that the train is traveling in a reverse direction at this time.

Sub-step S33: The accelerometer device performs weighted calculation or performs optimization on each channel pulse signals to eliminate external noise and other impact, and then calculates each channel of speed value and acceleration value.

In this method implementation, a three-axis accelerometer is used to analyze the characteristics of the X axis, Y axis, and Z axis. By measuring the voltages outputted in X, Y, and Z, the acceleration of coordinates in three directions may be learned. In the actual situation, for example: g is 0 by default, because 800 mv/g means a range of −1.5 g to 1.5 g, which indicates that the measured acceleration range is at most 1.5 g (g is one acceleration of gravity). For example, at this time, 800 millivolts outputted from x is measured, indicating that the acceleration in the x direction is 1 acceleration of gravity. If the acceleration in this state exceeds 1.5, the acceleration of gravity cannot be measured. When g is 1, and the sensor range is −6 g to 6 g, then the acceleration in three coordinate directions may be learned by measuring the output voltage. The speed value may be calculated through a distance the train travels in a fixed time, and the details are not described herein again.

Sub-step S34: The each channel of speed value and the acceleration value are outputted to the speed measurement processing device after the calculation is completed.

It should be noted that the accelerometer device not only receives the multi-channel speed sensor pulse signals, processes and calculates to obtain the speed value of each channel, but also a first accelerometer and a second accelerometer in the accelerometer device calculate to obtain the acceleration value of each channel based on the voltage difference, and outputs the speed value and the acceleration value of each channel to the speed measurement processing device after the calculation is completed.

Step S4: The speed measurement processing device receives and processes the detected normal pulse signal, and determines whether the speed value of each channel is in a reasonable interval based on the speed value and the acceleration value of each channel and determines whether the speed value of each channel in the reasonable interval conforms to the control logic and outputs the speed value of each channel to the logic processing device.

In this implementation, the detected normal pulse signal is inputted by the multi-channel speed sensor which after the speed sensor detection and switching device has detected normal. The speed measurement processing device processes the speed sensor detection and switching device detected normal pulse signal, to eliminate impact of other factors such as external noise and improve the signal accuracy.

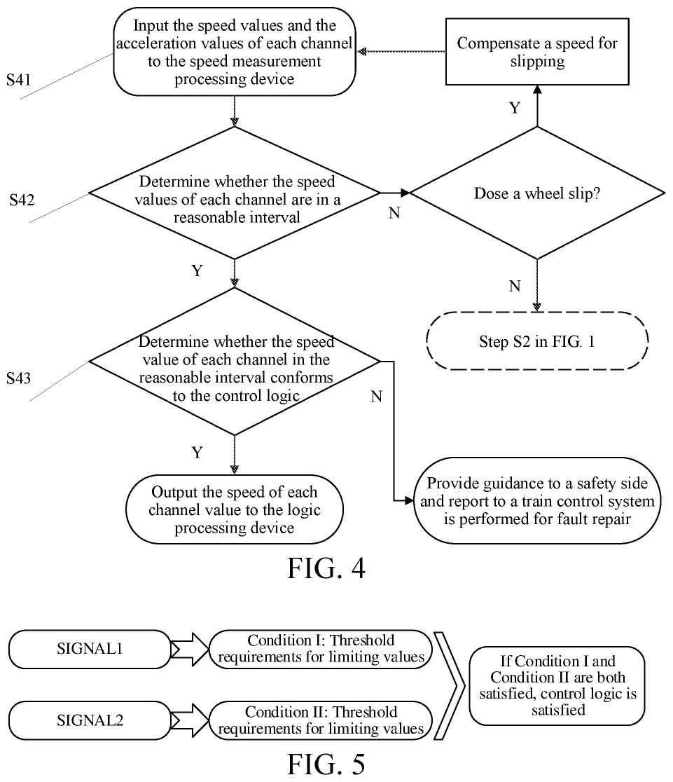

The process of determining properness and control logic of the speed value of each channel by the speed measurement processing device in this implementation is shown in FIG. 4, including the following sub-steps:

Sub-step S41: The speed values and the acceleration values of each channel are inputted to the speed measurement processing device.

Sub-step S42: It is determined whether the speed values of each channel are in a reasonable interval.

In this implementation, determining whether the speed values of the train are in a reasonable interval based on the speed value and acceleration value of each channel includes:

According to the acceleration value can determine if there is a large difference in the speed value.

If the acceleration value is negative, the speed value decreases;

If the acceleration value is zero, the speed value remains unchanged;

If the acceleration value is positive, the speed value increases.

The larger the acceleration value is, the larger the change value of the speed is, and a predicted speed value can be obtained by using the acceleration formula (acceleration (a)=change in speed (Δv)/time interval (Δt)), and if the speed value of each channel of the train is in a reasonable interval of this predicted speed value, the speed value is considered to be reasonable. The reasonable interval may be flexibly set by the skilled person in the art according to the performance parameters of the train in combination with practical needs, and is not described in detail herein again.

In this implementation, if the speed value is in the reasonable interval, sub-step S43 is performed. If the speed value is not in the reasonable interval, the system collects a wheel state. When the wheel state is abnormal and slipping occurs, the accelerometer device compensates the speed for the slipping, and then performs properness determination on the compensated value. If the wheel state is abnormal and no slipping occurs, step S2 is performed again. The speed measurement processing device determines whether the wheel slips based on the received speed value. If a difference exists between the received train speed value and the train speed value one second ago is excessively large, that is, the excessively large acceleration exceeds the acceleration determined by the slipping, it is considered that the wheel slips. The accelerometer device compensates the train speed and uses the slipping compensation acceleration as the default current acceleration to obtain a compensation speed v. When the speed value received by the speed measurement processing device is less than the compensation speed value v, the compensation ends. Based on the same method, if a difference between the received train speed value and the train speed value one second ago is excessively small, that is, the reverse acceleration exceeds the acceleration determined by slip, it is considered that the wheel slips. The accelerometer device compensates the train speed and uses the reverse slipping compensation acceleration as the default current acceleration to obtain a compensation speed v. When the speed value received by the speed measurement processing device is greater than the compensation speed value v, the compensation ends.

Sub-step S43: It is determined whether the speed value of each channel in the reasonable interval conforms to the control logic.

In the implementation method, if the speed value of each channel conforms to the control logic, the speed of each channel value is outputted to the logic processing device; and if the speed value does not conform to the control logic, the system provides guidance to the safety side and reports to a train control system for fault repair.

During the specific implementation of sub-step S43, the present disclosure further provides control logic of two typical embodiments.

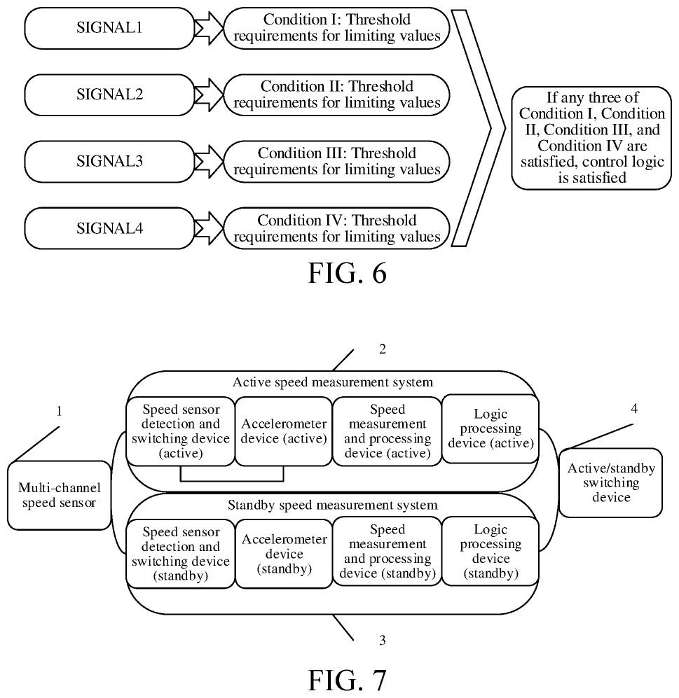

The control logic includes 2-out-of-2 control logic, with the specific schematic diagram shown in FIGS. 5, and 3-out-of-4 control logic, with the specific schematic diagram shown in FIG. 6.

The 2-out-of-2 control logic requires that two sets of inputted data simultaneously satisfy corresponding threshold conditions. The threshold conditions depend on requirements for limiting values of operation processes of the multi-channel speed sensor and a related wheel.

The 3-out-of-4 control logic requires that any three sets of four sets of data satisfy corresponding threshold conditions. The threshold conditions depend on requirements for limiting values of operation processes of the multi-channel speed sensor and a related wheel.

Based on the above, different control logics correspond to different test systems with different fault tolerance rates. The 2-out-of-2 control logic requires the lowest fault tolerance rate and high requirements for the whole system, and the 3-out-of-4 control logic requires a relatively high fault tolerance rate and relatively low requirements for the whole system. It should be noted that the control logic may be configured independently. This embodiment only lists two typical control logics. In actual use, the control logic may be configured independently as a separate device to satisfy different requirements of different trains for the accuracy of speed values. The configuration manner of the specific control logic is not described in detail herein again.

Step S5: A logic processing device receives the speed value of each channel outputted by the speed measurement processing device, and performs a consistency voting on the speed value of each channel outputted by the speed measurement processing device.

The voting process includes: speed value processing judgment and architecture logic judgment.

The speed value processing judgment includes calculating the external input signal value and judging whether the calculation result is consistent or not.

The architecture logic judgment is that, the first logic processor and the second logic processor in the active speed measurement system compare the important nodes and the final results in the calculation process to determine whether the calculation results are consistent; If the active speed measurement system shuts down due to a fault, the active speed measurement system is switched to the standby speed measurement system, and the first logical processor and the second logical processor of the standby speed measurement system compare the important nodes and the final results of the calculation process to determine whether the calculation results are consistent.

If it is determined that the calculation results of the speed value processing judgment are consistent and the calculation results of the architecture logic judgment are consistent, the consistency voting is approved.

Combining the 2-out-of-2 control logic (shown in FIG. 5) and the 3-out-of-4 control logic (shown in FIG. 6), the consistency voting is explained:

Regarding the 2-out-of-2 control logic: the results of the calculation of the two sets of signal values (SIGNAL1 and SIGNAL2) should be consistent (i.e., condition I and condition II are satisfied at the same time), and the important nodes and the final results of the calculation process of the first logic processor and the second logic processor of the active speed measurement system are consistent, then the consistency voting is approved.

Regarding the 3-out-of-4 control logic: the results of the calculation of any three of the four sets of signal values (SIGNAL1 to SIGNAL4) should be consistent (i.e., any three of conditions I, II, III, and IV are satisfied), and the important nodes and the final results of the calculation process of the first logic processor and the second logic processor of the active speed measurement system are consistent, then the consistency voting is approved.

The first logic processor and the second logic processor simultaneously output two values, and the two values are compared. If the error of the two values is within the specified range, the values are outputted to the train control system.

Step S6: A train running direction and the speed value are outputted to a train control system after the consistency voting is approved.

The full redundancy speed measurement system during train operation is only used as an example, and a person skilled in the art may perform adjustment according to the method and principle disclosed in the present disclosure. For example, in this embodiment, in order to reduce the system inspection burden and the speed jump caused by switching the speed measurement system, when the standby speed measurement system controls the train, it is not necessary to switch to the active speed measurement system to control the train if the active speed measurement system is restored in operation and can control the train independently. However, the technicians in the art may perform switching between the active speed measurement system and the standby speed measurement system in this case according to the actual application needs. When the train cannot control the train through the full redundancy speed measurement system and enter a fault emergency state, the train may always check the full redundancy speed measurement system in real time, so as to continue running when the train satisfies safe operation conditions, and when the train reaches the speed measurement condition of the safe operation of the train described in this embodiment, switching may be directly performed between the active speed measurement system and the standby speed measurement system as needed to continue running the train.

FIG. 7 is a schematic diagram of a full redundancy speed measurement system for a train according to the present disclosure. As shown in FIG. 7, the system includes a multi-channel speed sensor 1, an active speed measurement system 2, a standby speed measurement system 3, and an active/standby switching device 4. The active speed measurement system and the standby speed measurement system are both equipped with a speed sensor detection and switching device, an accelerometer device, a speed measurement processing device, and a logic processing device. The logic processing device includes a first logic processor and a second logic processor. The speed measurement processing device includes a first speed measurement processor and a second speed measurement processor. The accelerometer device includes a first accelerometer and a second accelerometer. The multi-channel speed sensor may be composed of n dual-channel speed sensors, or may be composed of n/2 four-channel speed sensors, or may be composed of n/3 six-channel speed sensors. In order to perform switching between channels of the multi-channel speed sensor when a problem occurs in a channel, a number of channels of the multi-channel speed sensor should be an integer and more than two. The multi-channel speed sensor is an axle speed sensor. The speed sensor has high accuracy but is easily affected by slipping. Therefore, during speed measurement, the accelerometer device is used to perform compensation in a case that the wheel slips. The multi-channel speed sensor inputting an original data signal into the speed measurement system for data processing includes: detecting, by the speed sensor detection and switching device, whether the power supply of the speed sensor and the pulse signal of the speed sensor are normal, and performing switching between different channel groups of the speed sensor and different speed sensors; and determining, by the speed measurement processing device, speed properness based on data of the accelerometer device. The logic processing device performs logic processing on data outputted by the speed measurement processing device, finally performs a consistency vote on the outputted speed value, and outputs data to the train control system after a unanimous vote. The active/standby switching device switches the speed measurement system, and the active speed measurement system and the standby speed measurement system are simultaneously operated.

Through comparison of the implementation of the present disclosure with the related art, according to the full redundancy speed measurement method for a rail train provided in the implementation of the present disclosure, the active speed measurement system and the standby speed measurement system are operated simultaneously, and the detection and switching function of the speed sensor is added, including a power supply and pulse monitoring function of the speed sensor, a switching function of the speed sensor, and a channel group switching function of the speed sensor. When the speed sensor channel is abnormal, the channel can be quickly switched, which realizes the redundancy of detection and switching and ensures the normal signal acquisition, so that the speed measurement system can receive the signal in real time to detect the current speed of the train and realize the control of the train.

In addition, according to the full redundancy speed measurement method for a rail train provided in this implementation of the present disclosure, both the active speed measurement system and the standby speed measurement system need to perform voting on the outputted results of the first logic processor and the second logic processor in the logic processing device. If the voting result is within a predetermined error range, the result is outputted to the train control system. Increasing unanimous voting can effectively avoid an error of the train control system caused by excessive data deviation caused by a step error in the calculation process, so as to avoid causing incorrect determination on the train control system due to incorrect speed values outputted from the train system.

In addition, the full redundancy speed measurement method for a rail train provided in this implementation of the present disclosure provides a logic control determination function, which includes 2-out-of-2 control logic or 3-out-of-4 control logic, and may further configure multiple logics according to specific requirements. Each control logic has different fault tolerance rates for data, so that a multi-level fault tolerance rate speed measurement system can be constructed, accidental errors and errors that need to be avoided under specific conditions can be directly filtered based on product demands and requirements, and the efficiency of the train control system is effectively improved.

In addition, more than two multi-channel speed sensors are required, so that both the active speed measurement system and the standby speed measurement system have pulse signals inputted during data processing, thereby avoiding a single signal source and realizing the redundancy of signal sources. The speed measurement system includes an active speed measurement system and a standby speed measurement system, and the accelerometer device, the speed measurement processing device, and the logic processing device in the active speed measurement system and the standby speed measurement system are all equipped with two units to process data simultaneously, thereby realizing redundancy of the data processing process. Switching may be performed between the active speed measurement system and the standby speed measurement system through the active/standby switching device, thereby realizing the redundancy of the whole speed measurement system. The full redundancy of the speed measurement system process improves the stability, safety, and practicability of the speed measurement system.

The specific implementation of the full redundancy speed measurement system for a rail train of the present disclosure is consistent with the operating principle of each device unit of the full redundancy speed measurement method for a rail train, and the details are not described again.

A person skilled in the art should understand that the foregoing embodiments are merely used for describing the technical solutions of the present disclosure, but are not intended to limit the present disclosure. Although the present disclosure has been described in detail with reference to the foregoing embodiments, a person skilled in the art may modify the technical solutions described in the foregoing embodiments, or replace some or all of the technical features with equivalents. However, these modifications or replacements may not cause the essence of corresponding technical solutions to depart from the scope of the claims of the present disclosure.

What is claimed is:

1. A full redundancy speed measurement method for a rail train, applicable to a full redundancy speed measurement system for a rail train, wherein the full redundancy speed measurement system for a rail train includes a multi-channel speed sensor, an active speed measurement system, a standby speed measurement system, and an active/standby switching device, the multi-channel speed sensor has a plurality of dual-channel groups, the active speed measurement system and the standby speed measurement system both include a speed sensor detection and switching device, a logic processing device, an accelerometer device, and a speed measurement processing device, and the method comprising:
operating the active speed measurement system and the standby speed measurement system,
performing, by the active/standby switching device, switching between the active speed measurement system and the standby speed measurement system;
inputting, by the multi-channel speed sensor, a pulse signal and a phase difference to the active speed measurement system and the standby speed measurement system, wherein a phase difference exists between channels in the dual-channel groups;
receiving, by the speed sensor detection and switching device, the pulse signal inputted by the multi-channel speed sensor, the speed sensor detection and switching device detecting, by the speed sensor detection and switching device, whether power supply of the multi-channel speed sensor and the pulse signal are normal, and outputting the detected normal pulse signal to the accelerometer device and the speed measurement processing device, and performing, by the speed sensor detection and switching device, switching between different multi-channel speed sensors and between different channel groups;
receiving, by the accelerometer device, the detected normal pulse signal and the phase difference, calculating, by the accelerometer device, a speed value and an acceleration value of each channel based on the detected normal pulse signal and outputting the speed value and the acceleration value of each channel to the speed measurement processing device, and determining a train running direction based on phase difference;
receiving and processing, by the speed measurement processing device, the detected normal pulse signal and determining whether the speed value of each channel is in a reasonable interval based on the speed value and the acceleration value of each channel, and determining whether the speed value of each channel in the reasonable interval conforms to the control logic and outputting the speed value of each channel to the logic processing device;
receiving, by the logic processing device, the speed value of each channel outputted by the speed measurement processing device, and performing, by the logic processing device, a consistency voting on the outputted the speed value of each channel; and
outputting a train running direction and the speed value to a train control system after the consistency voting is approved.

2. The speed measurement method according to claim 1, further comprising:
when the active speed measurement system and the standby speed measurement system are operated, switching to the standby speed measurement system when the active speed measurement system shuts down due to a fault, when the active speed measurement system resumes normality, switching of the speed measurement system is discontinued.

3. The speed measurement method according to claim 1, further comprising:
performing power supply diagnosis and reporting to the control system for fault repair if the speed sensor detection and switching device detects that a power supply state is abnormal; and
detecting whether the multi-channel speed sensor and a channel pulse are normal if the speed sensor detection and switching device detects that the power supply state is normal.

4. The speed measurement method according to claim 1, further comprising:
normally outputting the pulse signal of the multi-channel speed sensor if the speed sensor detection and switching device detects that the multi-channel speed sensor and a channel pulse state are normal; and
performing switching on the multi-channel speed sensor and the channel groups if the speed sensor detection and switching device detects that the multi-channel speed sensor and the channel pulse state are abnormal.

5. The speed measurement method according to claim 1, further comprising:
detecting the multi-channel speed sensor and the channel pulse again if switching of the multi-channel speed sensor and the different channel groups succeeds; and
providing guidance to a safety side and reporting to the control system for fault repair if the switching of the multi-channel speed sensor and the different channel groups fails.

6. The speed measurement method according to claim 1, further comprising:
calculating, by a first accelerometer and a second accelerometer in the accelerometer device, speed values, acceleration values, and phase differences.

7. The speed measurement method according to claim 1, further comprising:
processing, by a first speed measurement processor and a second speed measurement processor of the speed measurement processing device, the pulse signal of the multi-channel speed sensor, and determining whether the speed value of each channel is in the reasonable interval based on the speed value and the acceleration value of each channel;
performing control logic determination on the speed values of channels of the multi-channel speed sensor if an speed value of each channel of the multi-channel speed sensor is in the reasonable interval; and
determining whether a wheel slips if the speed value of each channel of the multi-channel speed sensor is not in the reasonable interval.

8. The speed measurement method according to claim 7, further comprising:
compensating, by the accelerometer device, the speed value for the slipping if the wheel slips; and
performing detection and switching on the multi-channel speed sensor and the channel groups if the wheel does not slip.

9. The speed measurement method according to claim 1, further comprising:
performing, by a first logic processor and a second logic processor of the logic processing device, logic processing on the data outputted by the speed measurement processing device;
outputting the speed values if the speed values of the channels of the multi-channel speed sensor conform to control logic; and
providing, by the system, guidance to the safety side and reporting to the train control system for fault repair if the speed values of the channels of the multi-channel speed sensor do not conform to the control logic.

10. The speed measurement method according to claim 7, wherein the logic determination comprises:
2-out-of-2 control logic and 3-out-of-4 control logic;
the 2-out-of-2 control logic requires that two groups of inputted speed values satisfy corresponding threshold conditions; the threshold conditions depend on requirements for limiting values of operation processes of the multi-channel speed sensor and a related wheel;
the 3-out-of-4 control logic requires that four groups of inputted speed values satisfy corresponding threshold conditions; and the threshold conditions depend on requirements for limiting values of operation processes of the multi-channel speed sensor and a related wheel.

11. The speed measurement method according to claim 1, further comprising:
performing a consistency voting on a speed value outputted by the speed measurement processing device, determining that the consistency voting is approved if a calculated result is within a set allowable error range, and outputting a final speed value to the train control system.

12. The speed measurement method according to claim 1, wherein
the logic processing device comprises a first logic processor and a second logic processor;
the speed measurement processing device comprises a first speed measurement processor and a second speed measurement processor; and
the accelerometer device comprises a first accelerometer and a second accelerometer.

13. The speed measurement method according to claim 1, wherein
the multi-channel speed sensor is composed of n dual-channel speed sensors, or composed of n/2 four-channel speed sensors, or composed of n/3 six-channel speed sensors.

14. The speed measurement method according to claim 2, further comprising:
performing power supply diagnosis and reporting to the control system for fault repair if the speed sensor detection and switching device detects that a power supply state is abnormal; and
detecting whether the multi-channel speed sensor and a channel pulse are normal if the speed sensor detection and switching device detects that the power supply state is normal.

15. The speed measurement method according to claim 2, further comprising:
normally outputting the pulse signal of the multi-channel speed sensor if the speed sensor detection and switching device detects that the multi-channel speed sensor and a channel pulse state are normal; and
performing switching on the multi-channel speed sensor and the channel groups if the speed sensor detection and switching device detects that the multi-channel speed sensor and the channel pulse state are abnormal.

16. The speed measurement method according to claim 3, further comprising:
normally outputting the pulse signal of the multi-channel speed sensor if the speed sensor detection and switching device detects that the multi-channel speed sensor and a channel pulse state are normal; and
performing switching on the multi-channel speed sensor and the channel groups if the speed sensor detection and switching device detects that the multi-channel speed sensor and the channel pulse state are abnormal.

17. The speed measurement method according to claim 14, further comprising:
normally outputting the pulse signal of the multi-channel speed sensor if the speed sensor detection and switching device detects that the multi-channel speed sensor and a channel pulse state are normal; and
performing switching on the multi-channel speed sensor and the channel groups if the speed sensor detection and switching device detects that the multi-channel speed sensor and the channel pulse state are abnormal.

18. The speed measurement method according to claim 2, further comprising:
detecting the multi-channel speed sensor and the channel pulse again if switching of the multi-channel speed sensor and the different channel groups succeeds; and
providing guidance to a safety side and reporting to the control system for fault repair if the switching of the multi-channel speed sensor and the different channel groups fails.

19. The speed measurement method according to claim 3, further comprising:
detecting the multi-channel speed sensor and the channel pulse again if switching of the multi-channel speed sensor and the different channel groups succeeds; and
providing guidance to a safety side and reporting to the control system for fault repair if the switching of the multi-channel speed sensor and the different channel groups fails.

20. The speed measurement method according to claim 14, further comprising:
detecting the multi-channel speed sensor and the channel pulse again if switching of the multi-channel speed sensor and the different channel groups succeeds; and
providing guidance to a safety side and reporting to the control system for fault repair if the switching of the multi-channel speed sensor and the different channel groups fails.
